(19) United States
(12) Patent Application Publication
(10) Pub. No.: US 2013/0223247 A1
(43) Pub. Date: Aug. 29, 2013

(54) APPARATUS AND METHOD FOR REDUCING VOICE CALL DELAY

(71) Applicant: Pantech Co., Ltd., (US)

(72) Inventors: Sung Oh BAE, Seoul (KR); Su Bok JI, Seoul (KR)

(73) Assignee: PANTECH CO., LTD., Seoul (KR)

(21) Appl. No.: 13/677,717

(22) Filed: Nov. 15, 2012

(30) Foreign Application Priority Data
Feb. 29, 2012 (KR) 10-2012-0021501

(51) Int. Cl. H04W 72/02; H04W 72/04

(52) U.S. Cl. CPC H04W 72/02; H04W 72/0406
USPC 370/252; 370/329

(57) ABSTRACT

A method for reducing delay in a voice calling operation includes entering into a packet switched network communication state on a mobile communication terminal, detecting an input associated with a voice calling operation, identifying a target legacy communication network cell for conducting the voice calling operation, and performing a camp-on operation on the target legacy communication network cell.

### CROSS-REFERENCE TO RELATED APPLICATION

This application claims the benefit of Korean Patent Application No. 10-2012-0021501 filed on Feb. 29, 2012, the contents of which are incorporated herein by reference in their entirety.

### BACKGROUND

1. Field

Exemplary embodiments of the present invention relate to a control method for reducing a voice call delay in a mobile communication terminal performing a voice call using circuit switched fallback (CSFB).

2. Discussion of the Background

Fourth Generation (4G) wireless networks, which may include a Long Term Evolution (LTE) wireless network, may support packet switching but not a voice over IP (VoIP) or circuit switching. Therefore, the 4G wireless network may use circuit switched fallback (CSFB) enabled second generation (2G) or third generation (3G) communication networks, such as wideband code division multiple access (WCDMA) or global system for mobile communications (GSM), to offer a voice call service for the 4G wireless network enabled mobile communication terminals. Accordingly, a mobile communication terminal supporting LTE or 4G communication standards may be manufactured to support both a 4G communication mode operating according to 4G communication standards (e.g., LTE standards), and a legacy communication mode operating according to existing communication standards (e.g., WCDMA standards).

Conventional voice communication using the conventional CSFB method may initiate a CSFB procedure for switching to a 2G or 3G network by sending a radio resource control (RRC) connection release command for releasing RRC connection (i.e., formation of a signaling path between a terminal and a LTE network) in a LTE communication network after performing RRC connection in the LTE network. Both performing the RRC connection in the LTE network and releasing of the RRC connection from the LTE communication network may be performed after a voice call request has been transmitted by dialing a phone number or identifying a contact and pressing the Call or Send button.

Therefore, some delay in accessing a voice call service may be present until the CSFB procedure is completed.

### SUMMARY

Exemplary embodiments of the present invention provide a control method for reducing a voice call delay in a mobile communication terminal performing a voice call using circuit switched fallback (CSFB).

Additional features of the invention will be set forth in part in the description which follows, and in part will be apparent from the description, or may be learned by practice of the invention.

Exemplary embodiments of the present invention provide a method for reducing delay in a voice calling operation including entering into a packet switched network communication state with a mobile communication terminal; detecting an input associated with a voice calling operation; identifying a target legacy communication network cell for conducting the voice calling operation; camping on the target legacy communication network cell; and establishing a radio resource control (RRC) connection to a legacy communication network via the target legacy communication network cell, in which the target legacy communication cell is identified before a voice call request is transmitted from the mobile communication terminal.

Exemplary embodiments of the present invention provide a mobile communication terminal including a first mobile communication modem to connect to a packet switched network communication network; a second mobile communication modem to connect to a legacy communication network; and a controller to detect an input associated with a voice calling operation, to identify a target legacy communication network cell to conduct the voice calling operation, to camp on the identified target legacy communication network cell, and to establish a RRC connection to a legacy communication network via the target legacy communication network cell, in which the target legacy communication cell is identified before a voice call request is transmitted.

Exemplary embodiments of the present invention provide a method for reducing delay in a voice calling operation including entering into a packet switched network communication state on a mobile communication terminal; detecting an input associated with a voice calling operation; identifying a target legacy communication network cell for conducting the voice calling operation; and performing a camp-on operation on the target legacy communication network cell.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a flowchart illustrating a voice communication method using a CSFB method.

FIG. 2 is a schematic block diagram of a mobile communication terminal illustrating a control method of a mobile communication terminal according to an exemplary embodiment of the present invention.

FIG. 3 is a flowchart illustrating a control method of a mobile communication terminal according to an exemplary embodiment of the present invention.

FIG. 4 illustrates a relationship between a mobile communication terminal and a network according to an exemplary embodiment of the present invention.

FIG. 5 is a flowchart illustrating a control method of a mobile communication terminal according to an exemplary embodiment of the present invention.

FIG. 6 illustrates a relationship between a mobile communication terminal and a network according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

The control method of a mobile communication terminal according to exemplary embodiments of the present invention may support both a legacy mobile communication method complying with the conventional mobile communication standard, and a new mobile communication method complying with a new mobile communication standard in the following manner.

According to the new mobile communication method, data communication may be performed through a packet switching (PS) network. According to the legacy mobile communication method, voice communication may be performed through at least a circuit switching (CS) network. Examples of the new mobile communication method may include, without limitation, a Long Term Evolution (LTE) communication method and a Worldwide Interoperability for Microwave Access (WiMAX) communication method. Examples of the legacy mobile communication method may include, without limitation, a global system for mobile (GSM) communication, a code division multiplexing access (CDMA) communication, and a wide code division multiplexing access (WCDMA) communication method.

In an LTE network may support the PS service, but not the voice service. When a mobile communication terminal transmits or receives a voice call, the voice call (i.e., CS call) may be performed by falling back from the LTE network and switching to the GSM or WCDMA network, which may be referred to as Circuit Switched Fallback (CSFB).

Hereinafter, the mobile communication method according to exemplary embodiments of the present invention will be described with respect to an LTE communication network (i.e., a 4G mobile communication method used for performing data communication), and a legacy communication network, which may utilize a 2G or a 3G mobile communication network to perform voice communication. However, aspects of the invention are not limited to the communication method stated above.

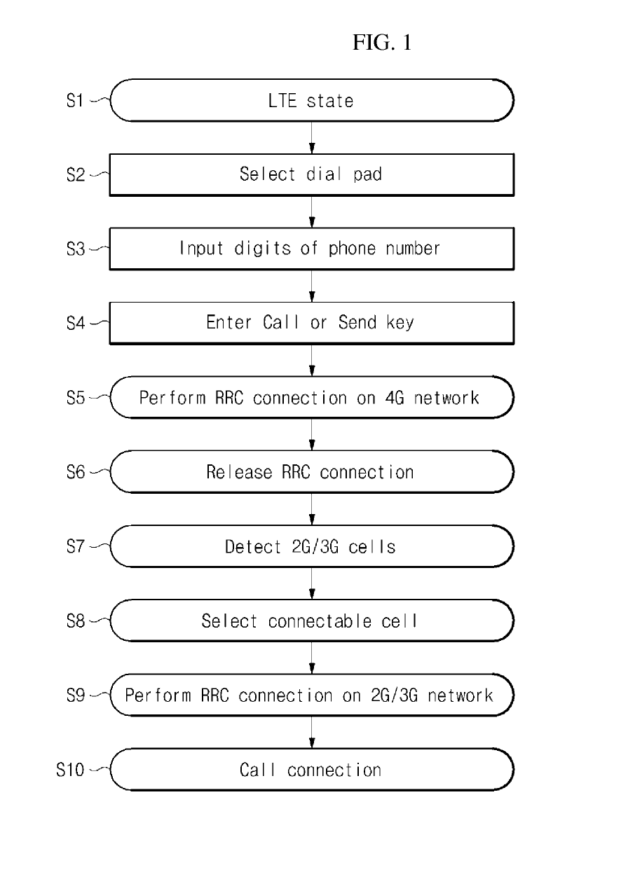

FIG. 1 is a flowchart illustrating a voice communication method using a general CSFB method.

Referring to FIG. 1, when a user attempts to make a voice call with a mobile communication terminal using 4G service, the voice call may be performed using a general CSFB method, which will now be described. Here, the mobile communication terminal may be compatible with 4G service, as well as 2G and/or 3G service. According to exemplary embodiments, the 4G service may be a packet switched network.

When the mobile communication terminal enters into an LTE state (S1), the user uses a dial pad to initiate a voice call connection operation (S2). Further, the user may input one or more digits corresponding to a phone number on the mobile communication terminal (S3) and then presses a Call or Send key to execute a calling operation (S4). However, aspects of the invention are not limited thereto, such that the user may execute the calling operation by using a touch screen or by speaking the phone number or shortcut thereto to the mobile communication terminal.

In response to execution of the calling operation in S4, the mobile communication terminal performs Radio Resource Control (RRC) connection to the 4G communication network (S5). The RRC connection may refer to a formation of a signaling path between the mobile communication terminal and the LTE network but is not limited thereto. In order to perform communication between the mobile communication terminal and the LTE network, the RRC connection may be established. In establishing the RRC connection, however, a time period of approximately 150 milliseconds (ms) may be expended.

After the RRC connection is established in S5, a RRC release signal to release the RRC connection (e.g., UE initiated fast dormant based on the WCDMA standard) is transmitted together with redirection information (S6). The redirection may refer to generation of an Internet Protocol (IP) address corresponding to a 2G or a 3G (e.g., WCDMA) communication network, but is not limited thereto. More specifically, because the 4 G communication network may be unable to accommodate a voice calling operation, the voice calling operation may be redirected to a 2G or 3G communication network to be executed. In general, a time period of approximately 50 (ms) may be expended in releasing the RRC connection and providing the redirection information.

In response to receiving the redirection information, the mobile communication terminal detects or identifies cells of the 2G or 3 G communication network that may be connected to for performing a voice calling operation or communication (S7). A time period of approximately 150 (ms) to 594 (ms) may be expended in detecting the 2G or 3G cells.

In addition, the mobile communication terminal selects one of the detected cells as a target cell to perform a camp-on procedure (S8), which may expend a timed period of approximately 1.38 seconds (s) to 3.00 (s).

The mobile communication terminal may perform a RRC connection on the selected cell of a 2G or a 3 G communication network (S9), and a voice call connection is established (S10).

In a related mobile communication of FIG. 1, RRC connection to the LTE communication network may require a time period of approximately 150 (ms), RRC release operation may require a time period of approximately 50 (ms), detection of a 2G or a 3G cell may require a time period of approximately 150 (ms) to 594 (ms), a camping operation may require a time period of approximately 1.38 (s) to 3.00 (s), and establishing a RRC connection to the detected cell in a 2G or a 3G network may require a time period of approximately 750 (ms) to 1.00 (s) until the voice call connection is established for the user to make a phone call. Therefore, a typical wait time for the user to establish a call connection in the mobile communication terminal may be at least 2.45 (s) to 4.8 (s) or more. Such delays in establishing a voice call in the mobile communication terminal may result in some deterioration in the voice communication quality and/or user convenience.

Hereinafter, an apparatus and a control method for reducing a voice call delay according to exemplary embodiments of the present invention will be described.

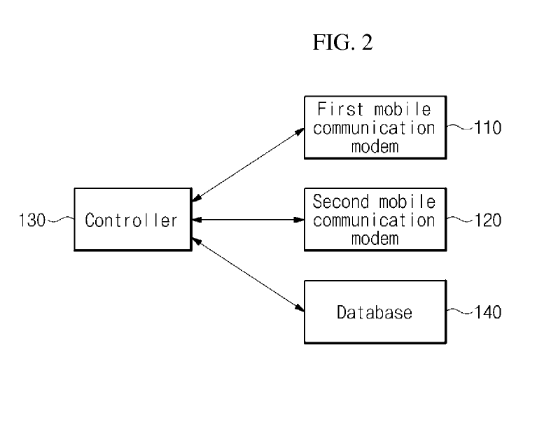

FIG. 2 is a schematic block diagram of a mobile communication terminal illustrating a control method of a mobile communication terminal according to an exemplary embodiment of the present invention.

As shown in FIG. 2, a mobile communication terminal according to an exemplary embodiment of the present invention includes a first mobile communication modem 110 to perform a data communication through an LTE network, a second mobile communication modem 120 to perform a voice communication through a legacy network (e.g., 2G or a 3G network), and a controller 130 to control the first mobile communication modem 110 and the second mobile communication modem 120 and their corresponding communication operations. In addition, the mobile communication terminal includes a database 140 to store data associated with the communication operations. Although the database 140 is illustrated as being included in the mobile communication terminal, the database 140 may be disposed separate therefrom and accessed through a communication network. The data communication method and voice communication method of the mobile communication terminal may be similar or substantially the same as the conventional methods. Accordingly, the following description will focus on some of the differences between the conventional methods and the inventive methods but are not limited thereto.

Referring to FIG. 2, the controller may control the first mobile communication modem 110 to enter into a LTE state, i.e., a packet switched network communication state. In the LTE state, the user may use a dial pad (not shown) or a similar mechanism to initiate a voice calling operation. In an example, the mobile communication terminal may initiate the voice call connection operation when the mobile communication terminal is flipped open if the mobile communication terminal is a folding type, or when a touch screen on a display screen of the mobile communication terminal is touched. Further, the user may initiate or execute the voice calling operation by speaking the phone number or a shortcut thereto to the mobile communication terminal.

In response to pressing of a first key on the dial pad or a similar mechanism, the controller 130 may control the second mobile communication modem to detect legacy communication network cells (i.e., 2G or 3G cells) that may be available. The controller 130 may determine using the second mobile communication modem 120, whether an appropriate or a target legacy communication network cell is detected. If the target legacy communication network cell is determined to be found, then the controller 130 may redirect connection to the found legacy network cell and establish a RRC connection. Accordingly, when the user has completed identifying a person to call by either dialing or entering in the phone number and presses the Call or the Send button to initiate the voice calling process, the user may be subject to less delay since processes to establish the RRC connection with the legacy communication network may be initiated before user submits the voice calling process. In an example, the database 140 may store one or more legacy communication network cells that may be capable of providing a voice calling operation for the mobile communication terminal. Accordingly, the controller 130 may attempt to detect the legacy communication network cells from the database 140.

However, if the controller 130 is unable to identify an appropriate or a target legacy communication network cell from the database 140, the controller may measure one or more attributes of legacy communication cells that may be located within a reference proximity from the mobile communication terminal. The mobile communication terminal may select the target legacy cell among the measured legacy communication cells based on the measured attributes. An attribute of the legacy communication cell may include at least one of transmission/reception signal intensity, proximity to the mobile communication terminal, preferential networks, and the like. When the target legacy communication network cell is identified, a camping process may be applied thereon and an RRC connection may be established to the legacy communication network via the target legacy communication network cell.

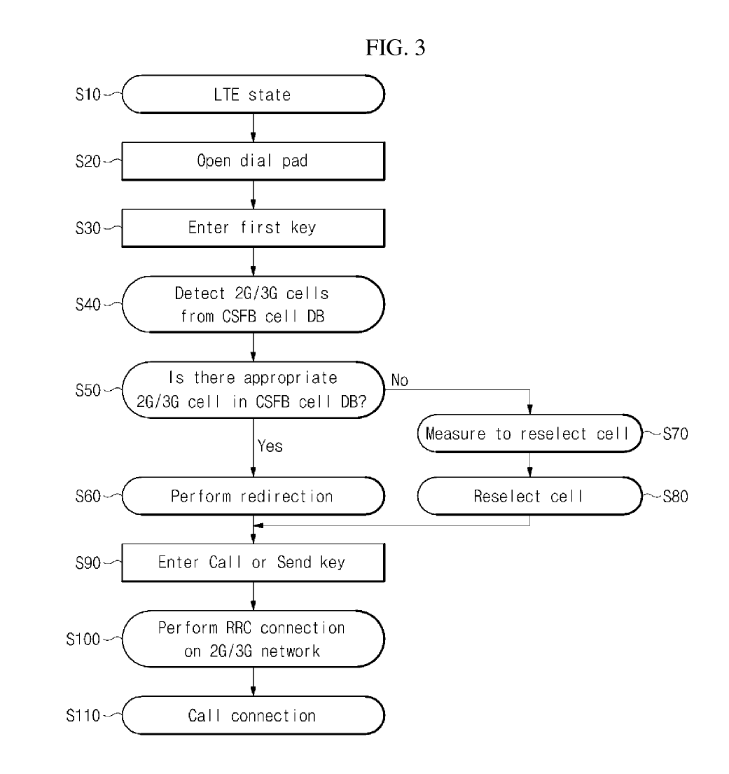

FIG. 3 is a flowchart illustrating a control method of a mobile communication terminal according to an exemplary embodiment of the present invention. The method of FIG. 3 below will be described as if performed by the mobile communication terminal of FIG. 2, but is not limited thereto.

Referring to FIG. 3, the mobile communication terminal may enter into a LTE state and may perform data communication using the LTE network. If data communication is not performed, however, a standby state may be maintained in a state in which the mobile communication terminal is connected to the LTE network (S10).

In the LTE state, if a user attempts to make a voice call, the user uses a dial pad on the mobile communication terminal to input a phone number (S20). In an example, the dial pad may be used or operated when the user opens the dial pad in the course of executing a home screen of the mobile communication terminal or a particular application program. In addition, the user may input one or more digits corresponding to a phone number on the dial pad or may select a contact to call by browsing the contacts directory and selecting an appropriate contact. However, aspects of the invention are not limited thereto, such that the user may execute the dialing operation by speaking the phone number or a shortcut thereto to the mobile communication terminal.

If the user enters a first input on the dial pad for establishing a voice call connection, that is, if the user inputs a first digit of the phone number on the dial pad or a first key for browsing an address or a contacts directory (S30), the controller 130 connects the mobile communication terminal to the 2G or 3G communication network by performing a CSFB operation through operations to be described later. According to exemplary embodiments, the first input may be a single input. More specifically, the mobile communication terminal may seek to identify appropriate resources in the legacy (e.g., 2G or 3G) communication network to support a voice calling operation in response to a determination that the user is attempting to initiate the voice calling operation.

Accordingly, since the user's mobile communication terminal initiates a connection to the 2G or 3G communication network when the first key corresponding to a phone number is inputted, the connection of the 2G or 3G communication network may be completed or already in progress by the time all of the digits of a phone number are entered and a Call or Send button is pressed. Similarly, such connection may be established by the time the user identifies a target contact, with whom the user may seek to perform communication via a voice calling operation. Therefore, since call communication using the 2G or 3G communication network may be established before, after, or upon the user completes the dialing process for attempting to make a voice call, the user may realize quality improvement in voice communication with reduced delay in making a voice call. Various operations of the CSFB operation will now be described in more detail. However, aspects of the invention are not limited thereto, such that a connection to the 2G or 3G communication network may be initiated after detecting a second key, a third key, and the like. Further, the mobile communication terminal may initiate a connection to the 2G or 3G communication network in response to a voice input corresponding to a digit or a name corresponding to a phone number.

When the user enters a first key from the dial pad (S30), the controller 130 detects or identifies legacy communication network cells using the 2G or 3G communication network from the database 140, which may store information on cells intended or capable of performing the CSFB operation (S40). The database 140 may store information of cells capable of performing the CSFB operation among cells using the 2G or 3G communication network. The cell information may include, without limitation, information on reception signal intensity, compatibility to the legacy communication network, compatibility to the 4G communication network, use preference by the mobile communication terminal, previous connections by the mobile communication terminal, and the like. A connectable cell among the cells stored in the database 140 may be determined based on the cell information.

The database 140 may be updated based on redirection information stored in connecting previous voice calls or neighboring cell information in system information transmitted from the 2G or 3G communication network. More specifically, redirection information and cell information may be changed or updated when a voice call is connected. The redirection information and the cell information may be changed after each voice call or at predetermined intervals.

In the conventional CSFB operation for performing voice communication, time period expended in detecting cells, which may be approximately 150 to 594 (ms) in duration, may occupy time the user has to wait for voice call connection. However, in the voice communication method according to an exemplary embodiment of the present invention, a cell detecting operation may be performed during the time when the user enters one or more keys associated with dialing the phone number in the mobile communication terminal. Accordingly, user's inconvenience caused by waiting for the voice call to be connected may be reduced or eliminated.

In S50, the controller 130 determines whether there is an appropriate or a target 2G or 3G cell among the detected cells (S50), and if there is an appropriate cell, redirection is performed on the cell (S60).

The time expended for the mobile communication terminal to perform a camp-on procedure on one of the detected cells, which may be approximately 1.38 (s) to 3.00 (s), may be associated with some inconvenience in waiting for the voice call connection. However, according to exemplary embodiments of the present invention, the switching to the 2G or the 3G communication service to perform a voice calling operation may be performed or executed during the time when the user inputs the phone number, so that the user may be subject to less waiting time in executing a voice calling operation from the mobile communication terminal. Therefore, the user may realize some reduction in the call delay when performing a voice calling operation from the mobile communication terminal in a 4G state.

Further, the mobile communication terminal may perform a camp-on procedure to a cell of the 2G or 3G communication network through redirection.

The redirection may refer to, without limitation, a generation of Internet Protocol (IP) corresponding to a 2G or 3G (e.g., WCDMA) communication network. The camp-on procedure may refer to, without limitation, a state in which an appropriate or a target cell is detected as the result of detecting cells to then be connected to the communication network.

Since the user may enter keys from the dial pad during the time that may be expended for the camp-on procedure, which may be approximately 1.38 (s) to 2.00 (s), a user may experience a reduction in call delay or may not experience any waiting time because the mobile communication terminal may establish a RRC connection to the legacy communication network by the time the user finishes the dialing process to initiate a voice calling operation.

After the redirection operation is completed, the user may complete inputting of the phone number and then enter a Call or Send key to initiate the voice calling process (S90). After entering the Call key, the controller 130 may perform a RRC connection on the camped-on 2G or 3G communication network (S100) to complete the CSFB procedure for establishing the voice call connection.

If there is no appropriate cell to be used in the 2G or 3G communication network, the controller 130 measures transmission/reception signal intensities or other attributes of detected cells for reselecting a cell (S70). More specifically, the controller 130 measures transmission/reception signal intensity with respect to a 2G or 3G cell base station that may be located within a reference proximity from a position of the mobile communication terminal by referring to the database 140. The controller 130 reselects an appropriate cell of the 3G communication network based on the measured transmission/reception signal intensity of respective cells (S80). Therefore, the mobile communication terminal may establish a camp-on state to the 2G or 3G communication network, instead of the normal state of 4G communication network. However, aspects are not limited thereto, such that the controller 130 may measure distances of the 2G or 3G cell base stations with respect to the mobile communication terminal, service provider of the respective cells, frequency of usage of the respective cells, and the like, in reselecting a cell.

Thereafter, the user may complete inputting of the phone number and then enter a Call or Send key to initiate the voice calling process (S90). After entering the Call key, the controller 130 may perform a RRC connection in the camp-on 2G or 3G communication network (S100) to complete the CSFB procedure and establish the voice call connection.

The RRC connection may generally expend a time period of approximately 50 (ms), which may be short in duration for the user to realize of the delay, so that call delay may not be detected by the user.

Some or all of operations of detecting a 2G or 3G cell from the database 140 (S40), performing redirection (S60), reselecting cells (S70 and S80) may be performed before the user enters the Call or Send key (S90). More specifically, while the user presses the digits of the phone number or browses the address directory, the CSFB procedure may be partially or completely performed. Thus, voice call connection may be achieved before, after, or when the user presses the key. Accordingly, a reduction in call delay may be detected or realized by the user in the course of performing the CSFB procedure, unlike in the conventional CSFB procedure in which a call delay may be realized by the user after the Call key is pressed.

Hereinafter, a voice communication method according to an exemplary embodiment of the present invention will be described with regard to an operation performed between a terminal and a network.

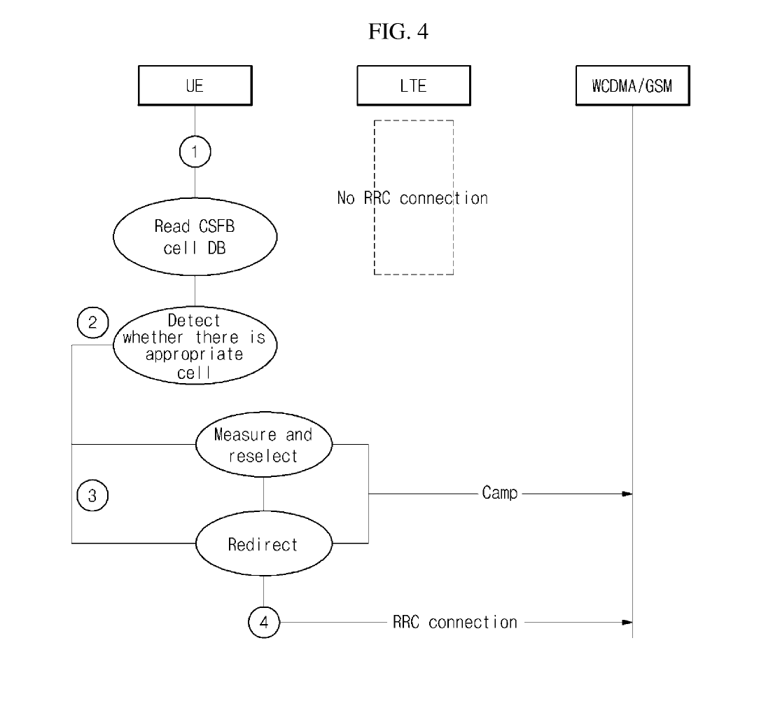

FIG. 4 illustrates a relationship between a mobile communication terminal and a network according to an exemplary embodiment of the present invention.

Referring to FIG. 4, the user selects a dial pad of a User Equipment (UE), such as the mobile communication terminal, and enters a key associated with inputting a phone number or browsing the address or contact directory, in step \textcircled{1}. The mobile communication terminal may be in a 4G communication mode or state at the time user enters the key associated with a voice calling operation.

Thereafter, the UE reads the database 140 storing information on a cell intended or capable of performing a CSFB procedure. The database 140 may be updated based on existing redirection information of the UE or neighboring cell information. In addition, the UE detects whether there is an appropriate cell of the 2G or 3G communication network from the database 140 in step \textcircled{2}.

Since the UE itself may determine that communication from the 4G communication may be switched to the 2G or 3G communication network, RRC connection may not be performed on the 4G communication network and an RRC release signal is not received in the 4G communication network. Therefore, in the voice communication method according to exemplary embodiments of the present invention, the RRC connection and the RRC release signal receiving operation may not performed on the 4G communication network, which may reduce delay in establishing the voice call connection.

In step \textcircled{3}, the UE determines whether there is an appropriate cell of the 2G or 3G communication network that may be stored in the database or not. If it is determined that there is an appropriate cell, the UE may perform a redirection operation on the cell to perform a camp-on procedure. If it is determined that there is no appropriate cell, the UE may measure transmission/reception signal intensities or other attributes of various cells with respect to a 2G or 3G cell base stations that may be located within a reference proximity to the UE to identify and a reselection operation is performed to identify or select the cell that may perform the camp-on procedure on the 2G or 3G communication network, such as WCDMA or GSM.

If the user completes inputting of the phone number and then enters a Call or Send key in step \textcircled{4}, the UE performs RRC connection on the camp-on cell of the 2G or 3G communication network. Accordingly, the user is able to perform a voice calling operation using the cell of the 2G or 3G communication network.

The user performs an operation of inputting digits of the phone number at operations \textcircled{2} and \textcircled{3}, which are between the step \textcircled{1} of entering at least the first key and operation \textcircled{4} of performing the voice call. Therefore, the user may not realize how much time is expended during the operations performed by the UE in steps \textcircled{2} and \textcircled{3} while the user is performing relevant operations in making a phone call. Accordingly, the user may not realize significant delays in establishing the voice communication method according to an exemplary embodiment of the present invention, thereby improving voice call quality.

As described above, in the voice communication method according to exemplary embodiments of the present invention, the mobile communication terminal may perform detection of a 2G or a 3G cell and the camp-on operation while the user may be inputting the phone number directly on the dial pad or browsing the address directory to identify a target contact. Accordingly, a voice call using the 2G or 3G communication network may be enabled with a reduced delay before, after, or when the user enters the Send key to establish a voice calling operation, thereby improving call quality.

Hereinafter, a control method for reducing a voice call delay in a mobile communication terminal according to an exemplary embodiment of the invention will be described.

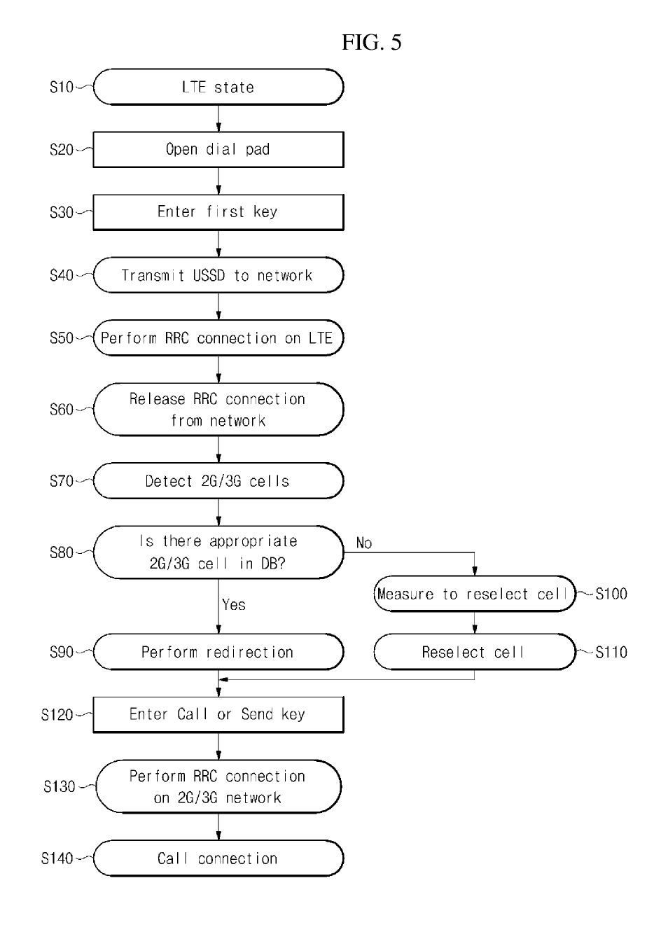

Referring to FIG. 5, in the control method of a mobile communication terminal according to an exemplary embodiment of the present invention, the mobile communication terminal may be in a LTE state and a data communication may be performed using a 4G communication network, or a standby state may be maintained (S10). Like in the previous exemplary embodiments, the user uses a dial pad to input a phone number or enter a first key for browsing the address directory to identify a contact to call (S20). However, aspects of the invention are not limited thereto, such that a connection to the 2G or 3G communication network may be initiated after detecting a second key, a third key, and the like. Further, the mobile communication terminal may initiate a connection to the 2G or 3G communication network in response to a voice input corresponding to a digit or a name corresponding to a phone number.

Thereafter, the mobile communication terminal transmits Unstructured Supplementary Services Data (USSD) to the 4G communication network (S40). Here, the USSD may be similar to Short Message Service (SMS) but the USSD may be faster than the SMS in view of transmission speed. Further, USSD messages may create a real-time connection during a USSD session. The USSD may be implemented for operations specialized to communication operators. More specifically, USSD may refer to a protocol used by GSM mobile communication terminals with the service provider's computers. Therefore, the USSD may be configured according to the prescribed regulations agreed with the communication operators. In the conventional USSD, since the user may directly input custom values in a prescribed format to then transmit the same to the network, the user may be obligated to remember the entered values and input the previously entered USSD values to execute a special operation. However, according to the exemplary embodiments of the present invention, when the USSD is used, the mobile communication terminal may automatically transmit the USSD when the user enters a first key from the dial pad without directly inputting the USSD from the terminal.

It is understood that the 4G communication network receives the USSD, and the mobile communication terminal performs a CSFB operation for voice call. Therefore, it may be possible to reduce a delay time expended in performing subsequent steps in the 4G communication network. In addition, USSD transmission may be performed while the user inputs the phone number, so that the user may not be subject to an extended waiting time after the user completes entering the phone number to perform a voice call operation.

The mobile communication terminal performs RRC connection to the 4G communication network (S50). In addition, since the 4G communication network grasps the CSFB operation for voice call, redirection information is transmitted together a RRC release signal for releasing RRC (S60). The RRC connection step may expend approximately 150 (ms) and the RRC releasing operation may expend approximately 50 (ms). The RRC connection and the RRC releasing operation may be performed while the user inputs the phone number. Therefore, the user may not realize or be subjected to significant call delays for these operations.

The steps from the mobile communication terminal detecting cells of the 2G or 3G communication network based on redirection information (S70) to performing of a voice call connection (S140) may be the same or similar as those of the previous exemplary embodiments, detailed descriptions thereof will be omitted.

Here, a time of approximately 1.38 (s) to 3.00 (s) may be expended in detecting cells or performing a camp-on procedure and a time of approximately 150 (ms) may be expended in performing a RRC connection. The user may input the phone number during the camp-on procedure and/or the RRC connection. Therefore, a reduction in call delay may be realized by the user.

Hereinafter, a voice communication method according an exemplary embodiment of the present invention will be described with regard to operations between a mobile communication terminal and communication networks.

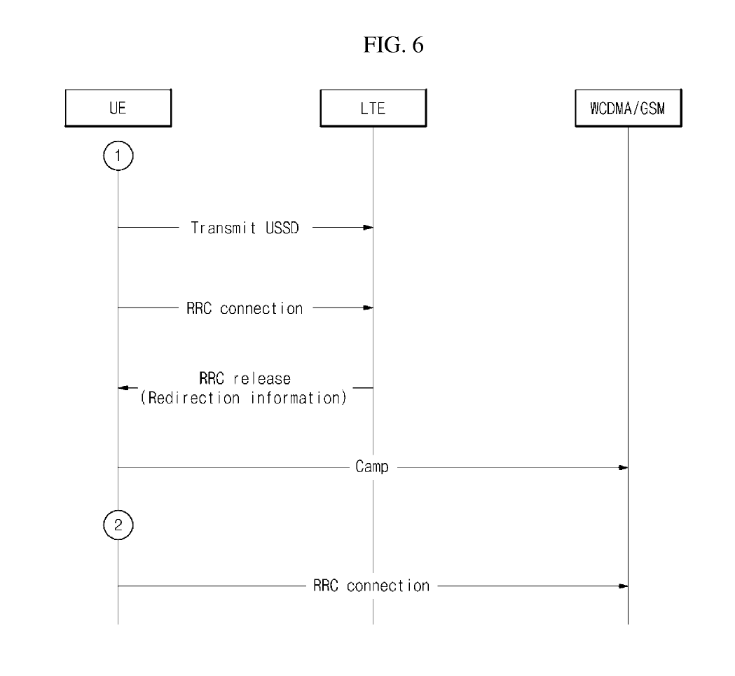

FIG. 6 illustrates a relationship between a mobile communication terminal and a network according to an exemplary embodiment of the present invention.

The flow chart of FIG. 6 will now be described with reference to various steps of FIG. 5.

Referring to FIG. 6, the user uses a dial pad of User Equipment (UE), such as a mobile communication terminal, in step \textcircled{1}. The user may then enter one or more keys for inputting a phone number or browsing a contact directory to identify a target contact to call.

Then, the UE transmits an Unstructured Supplementary Services Data (USSD) to a 4G communication network, such as a LTE network. Therefore, as described above, it may be understood that the 4G communication network receives the USSD and the mobile communication terminal may perform a CSFB operation for a voice call, thereby reducing a delay time expended in performing subsequent steps.

In addition, the UE performs or establishes a RRC connection to the LTE communication network. In addition, since the LTE communication network may use the CSFB operation for performing a voice calling operation, redirection information may be transmitted together with a RRC release signal for releasing RRC resources.

Accordingly, the UE starts to detect cells of the 2G or 3G communication network based on the redirection information. If it is determined that there is no appropriate cell to be used in the 2G or 3G communication network, the mobile communication terminal may perform a redirection operation on the cell to perform a camp-on procedure. In addition, if it is determined that there is no appropriate cell, the mobile communication terminal may attempt again to measure transmission/reception signal intensities or other attribute of detected cells for reselecting the cell. Further, the reselection may be performed to perform a camp-on procedure. In addition, since some or all of the steps of transmitting USSD, performing RRC connection, releasing the RRC connection, detecting cells and performing the camp-on operation may be performed while the user inputs the phone number or identifying a contact to make a voice call to, the delay time after the user transmits a call request may be reduced.

Meanwhile, if the user completes inputting the phone number and enters a Call or Send key in operation \textcircled{2}, the UE performs RRC connection in the selected cell of the 2G or 3G communication network. Therefore, the user can make a voice call through voice call connection.

As described above, in the voice communication method according an exemplary embodiment of the present invention, the operations of transmitting USSD, performing RRC connection, releasing the RRC connection, detecting cells of a 2G or 3G communication network and performing the camp-on operation may be performed while the user is inputting the phone number via the dial pad or enters a key for browsing the contact directory to identify a target recipient of the voice call. Therefore, voice communication operation using the 2G or 3G communication network on a mobile communication terminal that is capable of using a 4G service may be subject to reduced delay when the user finally enters a Send key to initiate the dialing process, thereby reducing a call delay.

While it has been described in the above-described exemplary embodiments that the user transmits a voice call, the same principle may be applied to a case where the user receives a voice call. More specifically, since switching from the LTE network to the 2G or 3G network may be largely or completely performed before the user performs a dialing process for receiving a voice call and detailed descriptions thereof can be sufficiently deduced from the above-described embodiments, repeated descriptions will be omitted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for reducing delay in a voice calling operation, comprising:
entering into a packet switched network communication state with a mobile communication terminal and detecting an input associated with a voice calling operation;
identifying a target legacy communication network cell for conducting the voice calling operation;
camping on the target legacy communication network cell; and
establishing a radio resource control (RRC) connection to a legacy communication network via the target legacy communication network cell,
wherein the target legacy communication cell is identified before a voice call request is transmitted from the mobile communication terminal.

2. The method of claim 1, wherein the legacy communication network comprises a second generation (2G) communication network and a third generation (3G) communication network.

3. The method of claim 1, wherein the identifying the legacy communication cell comprises:
identifying available legacy communication cells using a database;
determining whether the target legacy communication cell is present in the database; and
selecting the target legacy communication cell for establishing the RRC connection to the legacy communication network.

4. The method of claim 3, wherein the selecting the target legacy communication cell comprises receiving an internet protocol (IP) address corresponding to the target legacy communication cell.

5. The method of claim 1, wherein the identifying the target legacy communication cell comprises:
detecting available legacy communication network cells;
measuring attributes of detected legacy communication network cells; and
selecting the target legacy communication network cell based on at least one attribute of the detected legacy communication network cells.

6. The method of claim 5, wherein the attributes comprise at least one of a transmission signal intensity and a reception signal intensity.

7. The method of claim 1, further comprising:
transmitting data to the packet switched network communication network;
establishing a RRC connection to the packet switched network communication network; and
releasing the RRC connection to the packet switched network communication network,
wherein the data is transmitted before the identifying the target legacy communication network cell.

8. The method of claim 7, wherein an IP address of the target legacy communication network is received along with the releasing of the RRC connection to the packet switched network communication network.

9. The method of claim 7, wherein the transmitted data is Unstructured Supplementary Services Data (USSD).

10. A mobile communication terminal, comprising:
a first mobile communication modem to connect to a packet switched network communication network;
a second mobile communication modem to connect to a legacy communication network; and
a controller to detect an input associated with a voice calling operation, to identify a target legacy communication network cell to conduct the voice calling operation, to camp on the identified target legacy communication network cell, and to establish a radio resource control (RRC) connection to a legacy communication network via the target legacy communication network cell,
wherein the target legacy communication cell is identified before a voice call request is transmitted.

11. The mobile communication terminal of claim 10, wherein the legacy communication network comprises a second-generation (2G) communication network and a third-generation (3G) communication network.

12. The mobile communication terminal of claim 10, further comprising a database to store a list of available legacy communication cells.

13. The mobile communication terminal of claim 12, wherein the controller identifies available legacy communication cells using the database, determines whether the target legacy communication cell is present in the database, and selects the target legacy communication cell to establish the RRC connection to the legacy communication network.

14. The mobile communication terminal of claim 10, wherein the controller receives an internet protocol (IP) address corresponding to the target legacy communication cell.

15. The mobile communication terminal of claim 10, wherein the controller detects available legacy communication network cells, measures attributes of detected legacy communication network cells, and selects the target communication network cell based on at least one attribute.

16. The mobile communication terminal of claim 15, wherein the attributes comprise at least one of a transmission signal intensity and a reception signal intensity.

17. The mobile communication terminal of claim 10, wherein the first mobile communication modem transmits data to the packet switched network communication network, establishes a RRC connection to the packet switched network communication network, and releases the RRC connection to the packet switched network communication network,
wherein the data is transmitted before the target legacy communication network cell is identified.

18. The mobile communication terminal of claim 17, wherein the controller receives an IP address of the target legacy communication network when the RRC connection to the packet switched network communication network is released.

19. A method for reducing delay in a voice calling operation, comprising:
entering into a packet switched network communication state on a mobile communication terminal and detecting an input associated with a voice calling operation;
identifying a target legacy communication network cell for conducting the voice calling operation; and
performing a camp-on operation on the target legacy communication network cell.

20. The method of claim 19, wherein a radio resource control (RRC) connection is established with a legacy communication network via the target communication network cell in response to the mobile communication terminal transmitting a voice call request.
